(19) United States
(12) Patent Application Publication
(10) Pub. No.: US 2026/0307577 A1
(43) Pub. Date: Oct. 8, 2026

(54) APERTURE COVER

(71) Applicant: Oxbow Gear LLC, Ephraim, UT (US)

(72) Inventor: Clayton Krebs, Ephraim, UT (US)

(21) Appl. No.: 19/568,791

(22) Filed: Mar. 17, 2026

Related U.S. Application Data
(60) Provisional application No. 63/773,299, filed on Mar. 17, 2025.

(51) Int. Cl. B60P 3/34; A01M 29/30

(52) U.S. Cl. CPC B60P 3/34; A01M 29/30

(57) ABSTRACT

An aperture cover to at least partially obstruct the space between a slide member and a wall opening through which the slide member extends for in-and-out movement relative to the wall opening. The cover includes a plate having a width and a height larger than a width and height of the wall opening. The plate includes an opening sized to closely fit transversely on the slide member. The cover includes at least one magnet secured to the plate between an edge of the plate and the plate opening.

### PRIORITY CLAIM

This application claims benefit of U.S. provisional Application No. 63/773,299 filed Mar. 17, 2025, entitled APERTURE COVER, which is hereby incorporated by reference in its entirety.

### TECHNICAL FIELD

This application relates generally to aperture covers, and more specifically to physical barriers to protect against rodents or other creatures entering a space. The aperture covers may be used, for example, in recreational vehicles or travel trailers.

### BACKGROUND

Recreational vehicles and travel trailers often include a slide-out, an extendable section that increases living space within the recreational vehicle or travel trailer. The slide-out is typically guided in its movements in and out of the main body of the recreational vehicle by one or more shafts (e.g., slide rods, drive shafts, etc.) within the lower frame of the recreational vehicle (e.g., travel trailer, recreational vehicle, etc.). The shaft moves in and out of an opening in the frame on a side of the vehicle. This movement transitions the slide-out between a stowed position (e.g., while the vehicle is in transit) and an extended, deployed position (e.g., while the space is being lived in).

These shafts are not perfectly straight and/or their movement is not always straight. As a result, the shafts have some non-axial movement as they move laterally in and out relative to the frame. An enlarged opening in the frame accommodates such non-axial movement. However, the opening being large enough to accommodate non-axial movement of the slide rod as it extends and retracts from the frame comes with a downside. Specifically, the opening in the frame is large enough for rodents or other creatures to enter. Once they enter the frame, they often have access to the systems of the recreational vehicle that are housed under the interior floor of the vehicle. The access might extend to vents and other openings that also permit access to the full interior of the recreational vehicle. Because the shafts move in and out of the frame, standard foam sealants or insulation would not stay in place and are thus not a viable solution to this problem.

### SUMMARY

Embodiments disclosed herein provide an aperture cover that more closely engages with the shaft (e.g., a slide rod) to help stop rodents and other animals from entering a recreational vehicle, while also allowing movement of the aperture cover to account for non-axial movement of the shaft.

According to some embodiments, an aperture cover is provided that includes a cover plate securable over an opening in a surface while allowing slight movements of the cover plate to accommodate shifts in a member that moves relative to the opening in the surface. For example, in one application, the cover plate is securable to the frame of a recreational vehicle or travel trailer that includes a slide-out with a shaft that moves transversely to a frame member in and out of an opening in the frame member as the slide moves to and from a stowed position and an extended, deployed position.

The aperture cover obstructs an opening between a movable shaft or slide member and a wall opening into which the shaft extends and retracts. The cover includes a plate and a magnet secured to the plate. The plate has a width and a height larger than a width and height of the wall opening. The plate includes an opening sized to closely fit transversely on the slide member. The magnet is secured to the plate between an edge of the plate and the plate opening.

Preferably, the includes a slot extending from the plate opening to the edge. The plate is flexible such that the plate can be separated at the slot for insertion onto the slide member without removal of the slide member.

In a preferred embodiment, the multiple magnets are secured to the plate on opposite sides of the plate opening. The magnets may be riveted into place on the plate or adhesively applied to a front or back face of the plate. A recess may be provided in the plate surface to receive the magnet.

The plate may be made of metal (such as aluminum, steel, spring steel, or stainless steel), plastic, or composite.

In one preferred embodiment for certain applications, the plate includes a base plate and a top plate slidingly engaged with the base plate. The top plate has a top plate opening. The base plate also has an opening. The base plate opening being larger than the top plate opening. The top plate overlaps the opening in the base plate. In one example, the base plate includes a base magnet sheet on a backside thereof for engagement with the wall or surface to which the plates are secured to cover the aperture. Furthermore, the top plate includes a magnet receptor to slidingly engage with the base plate and be slidingly held thereto.

The top plate preferably includes a top plate slot extending from the top plate opening to an edge of the top plate.

Preferred embodiments herein also include a method of covering a gap between the sides of a moveable shaft and the edges of a metal (ferrous) wall opening with a plate such as that set forth above. The method includes (1) securing the plate with the shaft extending through the opening in the plate and (2) engaging the magnet with the metal wall. The plate is able to shift its position on the metal wall as the shaft moves through the opening in the plate and pushes it side to side transverse to the primary movement of the shaft and parallel to the wall to which the plate is magnetically held.

The plate is preferably coupled or secured to the shaft by elastically separating the flexible plate at the slot to slide over the shaft. Once the plate slides over the shaft the slot comes back together with the plate substantially flat again.

In the embodiment with the base plate and the top plate, the base plate shifts on the wall and the top plate can shift on the base plate as needed while still substantially keeping the gap to a minimum.

### BRIEF DESCRIPTION OF THE DRAWINGS

Non-limiting and non-exhaustive embodiments are described in detail below with reference to the following drawings. For a better understanding of embodiments, reference will be made to the following Detailed Description, which is to be read in association with the accompanying drawings.

FIG. 1A illustrates a recreational vehicle with a slide-out in a stowed position according to some embodiments.

FIG. 1B illustrates a recreational vehicle with a slide-out in an extended position according to some embodiments.

FIG. 2 illustrates a portion of a recreational vehicle with a frame wall having an opening for a sliding member according to some embodiments.

FIG. 3 illustrates a portion of a recreational vehicle with a frame wall having an opening for a sliding member according to some embodiments.

FIG. 4 illustrates an aperture cover covering a frame wall opening according to some embodiments.

FIG. 5 illustrates an aperture cover covering a frame wall opening according to some embodiments.

FIG. 6 is a front view of an aperture cover according to some embodiments.

FIG. 7 is a back view of an aperture cover according to some embodiments.

FIG. 8 illustrates a portion of a recreational vehicle with a frame wall having an opening for a sliding member according to some embodiments.

FIG. 9 illustrates an aperture cover covering a frame wall opening according to some embodiments.

FIG. 10 is a perspective view of an aperture cover according to some embodiments.

FIG. 11 is an exploded view of an aperture cover according to some embodiments.

FIG. 12 is a plan view of a base plate of an aperture cover according to some embodiments.

FIG. 13 is a plan view of a top plate of an aperture cover according to some embodiments.

FIG. 14 illustrates an aperture cover covering a frame wall opening according to some embodiments.

FIG. 15 is a perspective view of a plate of an aperture cover according to some embodiments.

FIG. 16 is a perspective view of an aperture cover according to some embodiments.

FIG. 17 is a plan view of an aperture cover according to some embodiments.

### DETAILED DESCRIPTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather these embodiments are provided so that this disclosure will be thorough and complete, and will fully convey the scope of the embodiments to those skilled in the art. Among other things, the various embodiments may be methods, systems, or devices. The following detailed description should, therefore, not be limiting

Throughout the specification and claims, the following terms take the meanings explicitly associated herein, unless the context clearly dictates otherwise. The term “herein” refers to the specification, claims, and drawings associated with the current application. The phrase “in some embodiments” as used herein does not necessarily refer to the same embodiments, though it may. Thus, as described below, various embodiments of the invention may be readily combined, without departing from the scope or spirit of the invention. In addition, as used herein, the term “or” is an inclusive “or” operator, and is equivalent to the term “and/or,” unless the context clearly dictates otherwise. In addition, throughout the specification, the meaning of “a,” “an,” and “the” include plural references.

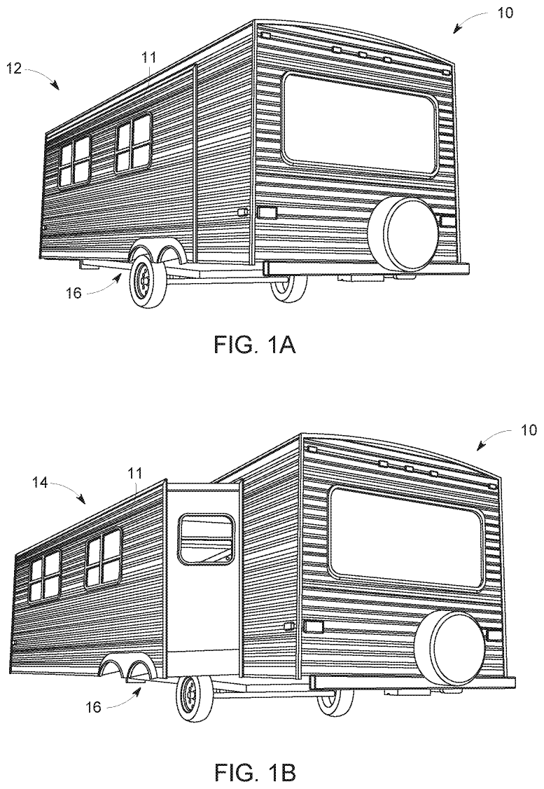

As discussed in the background section, slide-outs in recreational vehicles rely on frame openings large enough to accommodate non-axial shaft movement, but these openings also allow rodents and other pests to enter the vehicle's underfloor and interior spaces. For example, referring to FIGS. 1A and 1B, a recreational vehicle 10 may have a slide-out 11 that can transition between a stowed position 12 (as shown in FIG. 1A) and an extended position 14 (as shown in FIG. 1B). Recreational vehicle 10 may be a travel trailer, a fifth-wheel trailer, a motorhome, a truck camper, or any other kind of recreational vehicle or similar system that includes a slide-out. In some embodiments, recreational vehicle 10 comprises a lower frame area 16. Lower frame area 16 includes structure and mechanisms that facilitate the movement of slide-out 11 between stowed position 12 and extended position 14. There are a variety of different slide mechanisms used in recreational vehicles, including electric rack and pinion mechanisms and hydraulic slide mechanisms.

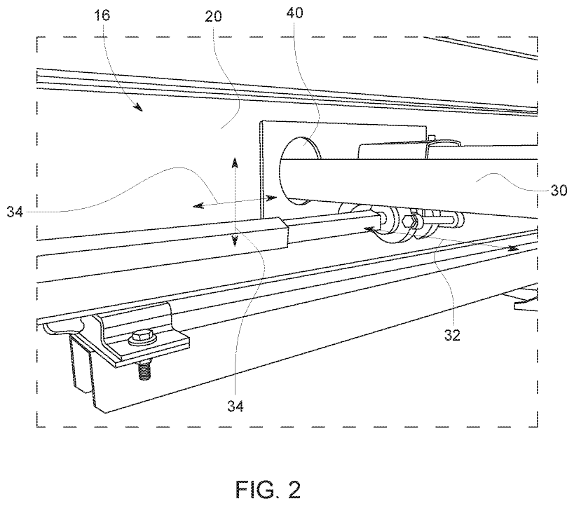

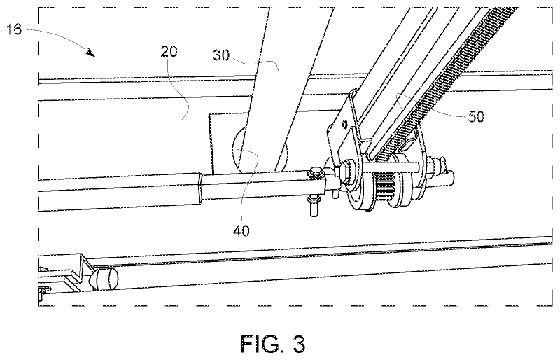

A close-up view of an example lower frame area 16 is shown, for example, in FIGS. 2 and 3. Lower frame area 16 comprises a frame member 20 that has an opening or aperture 40 therein. Frame member 20 more generally represents any surface that has an aperture 40, whether it be in a recreational vehicle or some other application. A shaft 30 (which may be a slide rod or some other shaft) extends through aperture 40. Shaft 30 may move in its longitudinal direction 32 (also referred to as the axial direction) to move slide-out 11 between stowed position 12 and extended position 14. As discussed above, shaft 30 may also move in transverse directions 34 (also referred to as non-axial direction) because shaft 30 may not be perfectly straight or the travel of shaft 30 may not be perfectly axial. While two transverse directions 34 are illustrated in FIG. 2, transverse direction 34 includes a combination of movement in the two illustrated directions. Stated differently, transverse direction 34 includes any movement in a non-axial direction, which would be any direction along the plane created by the two illustrated transverse directions 34.

In FIG. 2, a slide rod 30 is shown forward of a drive shaft (shown in FIG. 3 as a rack-and-pinion drive shaft 50). The slide rod 30 is positioned within opening 40 in the frame member 20 of the recreational vehicle 10. The opening 40 is large enough to accommodate non-axial movement (i.e., in transverse directions 34) of the slide rod 30 as it extends and retracts (i.e., in longitudinal direction 32) from the frame member 20. Thus, the opening 40 in the frame member 20 is large enough for rodents or other creatures to enter. Once they enter the frame member 20, they often have access to the systems of the recreational vehicle 10 that are housed under the interior floor of the vehicle. The access might extend to vents and other openings that also permit access to the full interior of the recreational vehicle 10. The drive shaft (e.g., rack and pinion drive shaft 50 may have more or less clearance. In the case of FIG. 3, the clearance around the drive shaft 50 is less than that around the slide rod 30. Since these shafts 30, 50 move in and out of the frame member 20, standard foam sealants or insulation would not stay in place and cannot be used to block pests from accessing recreational vehicle 10. Accordingly, there remains a need for solutions that will prevent rodent and other pests from entering recreational vehicles.

This disclosure relates to systems, methods, and devices designed to cover frame openings while still accommodating non-axial shaft movement of a slide member that extends through the frame opening. For example, the present disclosure details a cover plate securable over an opening in a surface while allowing slight movements of the cover plate to accommodate shifts in a member that moves relative to the opening in the surface. In one application, the cover plate is securable to the frame of a recreational vehicle or travel trailer, such as recreational vehicle 10 that includes slide-out 11 with a shaft 30 that moves in longitudinal direction 32 in and out of opening 40 in frame member 20 as the slide-out 11 moves to and from a stowed position 12 and an extended, deployed position 14. The aperture covers disclosed herein may be used for either or both of slide rod 30 and drive shaft 50 discussed above, or any other slide rods or drive shafts. In addition, the aperture covers disclosed herein may be used in connection with electric rack and pinion mechanisms, hydraulic slide mechanisms, or other mechanisms.

In some embodiments, an aperture cover provides a plate that more closely engages with the slide rod 30 and/or drive shaft 50 to help stop rodents and other animals from entering recreational vehicle 10. For example, an aperture cover may include a cover plate and a mechanism to secure the cover plate to the frame 20 in longitudinal direction 32 (i.e., axial direction) of the slide member 30 while allowing movement of the cover plate in transverse directions 34 (i.e., non-axial directions). The cover plate may be sized to cover or at least partially cover the frame opening 40. The cover plate may include an opening sized to closely fit around a slide member, such as a shaft. In some embodiments, the mechanism to secure the cover plate comprises a magnet, which may be attached to the cover plate. Various embodiments of aperture covers are described below. Although the disclosure primarily focuses on recreational vehicles, the aperture covers discussed herein may be applied to other scenarios where it is desirable to cover an opening in a wall, frame, or similar structure, while accommodating shaft movement through the opening.

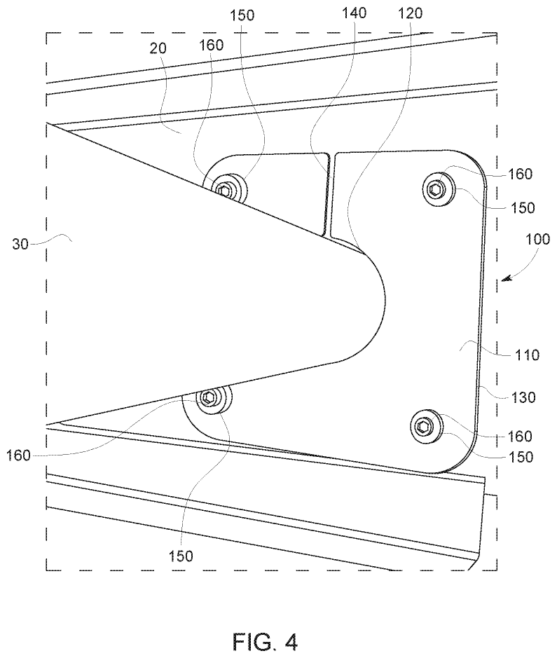

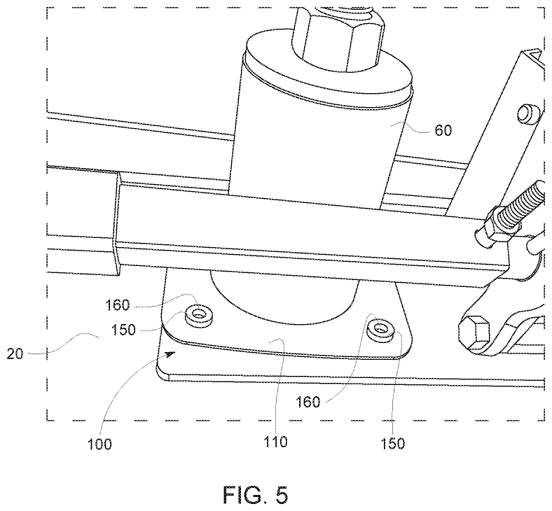

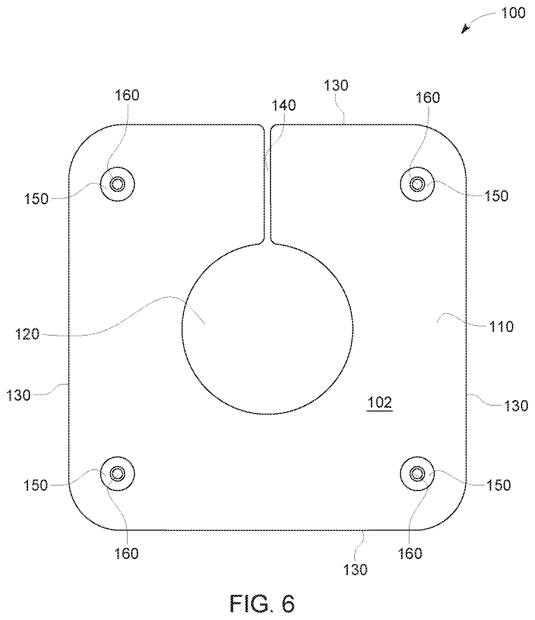

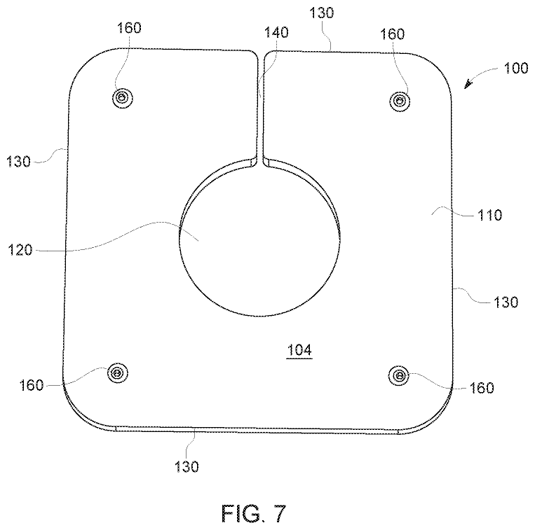

An example aperture cover 100 is shown, for example, in FIGS. 4-7. FIGS. 4 and 5 show aperture cover 100 installed on recreational vehicle 10 around shaft 30. FIG. 6 shows aperture cover 100 with its front face 102 that faces away from frame member 20 when installed on recreational vehicle 10. FIG. 7 shows aperture cover 100 with its back face 104 that faces towards frame member 20 when installed on recreational vehicle 10. The features discussed with respect to aperture cover 100 may also apply to other aperture covers that are discussed herein even if those details are not expressly repeated. In some embodiments, aperture cover 100 includes cover plate 110 and a securing mechanism 150 (which may be one or more magnets 150, as in FIGS. 4-7) to secure cover plate 110 to frame 20.

Cover plate 110 may be constructed of a variety of different materials. In some embodiments, cover plate 110 is constructed of a flexible material. For example, cover plate 110 may be made of a material that is flexible enough to be placed around shaft 30 (as discussed in more detail below). In some embodiments, cover plate 110 is made of a plastic (such as ABS plastic), a metal (such as stainless spring steel), or a composite. In some embodiments, a metal is used to avoid damage when a slide-out 11 is closed and applies significant force to cover plate 110. For example, stainless spring steel works well for cover plate 110, even when slide-out 11 includes a can 60 (see FIG. 5) provided on shaft 30 that may apply force on cover plate 110 when slide-out 11 transitions to stowed position 12. Using stainless spring steel for cover plate 110 also avoids rust and corrosion.

Cover plate 110 includes an opening 120. In some embodiments, opening 120 may be positioned in a center of cover plate 110, although other positions are possible. Opening 120 may be dimensioned to more closely fit around slide rod 30 compared to aperture 40. In some embodiments, opening 120 may be sized to fit closely around shaft 30. In some embodiments, opening 120 may be sized to fit around shaft 30 with less than a 0.5 inch gap between shaft 30 and cover plate 110. In some embodiments, opening 120 may be sized to fit around shaft 30 with less than a 0.1 inch gap between shaft 30 and cover plate 110. In some embodiments, opening 120 may be sized to fit around shaft 30 with less than a 0.05 inch gap between shaft 30 and cover plate 110. In some embodiments, opening 120 has a diameter of about 1.5 to 2.5 inches. For example, opening 120 may have a diameter of about 2 inches or about 1.875 inches.

Cover plate 110 may also comprise an edge 130 defining an outer boundary of cover plate 110. Other tolerances may be used. Cover plate 110 (extending from edge 130 into opening 120) is configured to at least partially cover or obstruct the space between slide member 30 and frame 20, or in other words aperture 40.

A variety of shapes may be used for cover plate 110. For example, cover plate 110 may be a square, a rectangle, a circle, an oval, a star, or any other polygonal or non-polygonal shape. Cover plate 110 may be any shape as long as it is large enough to cover the frame opening 40 and allow securement locations for magnets 150 (or other securement mechanisms 150). Cover plate 110 may have sharp or rounded corners. Regardless of the shape, cover plate 110 is sized to be large enough to cover aperture 40 (and to ensure magnets 150 do not interfere with can 60 (see FIG. 5)), while also not being so large as to interfere with other structure within lower frame area 16. In some embodiments, cover plate 110 has a height and a width that is greater than a height and a width of aperture 40 (see FIGS. 2 and 3). In some embodiments, cover plate 110 may have a height of between three inches and six inches and a width of between three inches and six inches. For example, in some embodiments, cover plate 110 may have a height of 4.5 inches and a width of 4.5 inches.

A variety of thicknesses may be used for cover plate 110. In some embodiments, cover plate 110 has a thickness that allows enough flexibility for cover plate 110 to be installed onto slide rod 30 but is not too flimsy to withstand impact forces or allow for pests to get around cover plate 110. In some embodiments, cover plate 110 has a thickness of less than about 0.1 inches. For example, cover plate 110 may have a thickness of about 0.06 inches or about 0.02 inches (e.g., 0.024 inches). Other thicknesses may also be used.

In some embodiments, cover plate 110 includes a slot or cut 140. Slot 140 extends from opening 120 to edge 130. The slot 140 allows cover plate 110 to be installed onto slide rod 30 without disassembly of the rod 30 in any way. For example, cover plate 110 may be simply elastically flexed open at slot 140 to be placed on the rod 30. The plate 110 may then be slid up against the frame member 20. In some embodiments, slot 140 is a break between two parts of cover plate 110 without any material being removed from cover plate 110. Thus, the two parts of cover plate 110 may come into contact at slot 140. In some embodiments, slot 140 provides a gap. A width of slot 140 may be less than 0.2 inches or less than 0.1 inches. For example, slot 140 may have a width of 0.06 inches.

As noted above, aperture cover 100 includes securing mechanism 150, in addition to cover plate 110. Securing mechanism 150 is configured to secure cover plate 110 to frame 20. In some embodiments, securing mechanism 150 comprises one or more magnets 150 (as shown, for example, in FIGS. 4-7), which will be attracted to frame 20, which is made of at least partially ferrous metal. Although FIG. 6 shows aperture cover 100 with four magnets 150, other numbers of magnets 150 may be used. Magnet(s) 150 may be secured to cover plate 110 to hold the plate 110 to the frame member 20 while still allowing the plate 110 to shift slightly as the slide rod 30 moves in small amounts side-to-side (in transverse directions 34) relative to the frame opening 40. Thus, magnets 150 provide a force to hold the plate 110 to the frame member 20 while such magnets shift or slide along the surface of the face of the frame member 20.

In some embodiments, magnets 150 may be secured to plate 110 on opposite sides of opening 120. For example, a magnet 150 may be secured in each corner of plate 110, as shown in FIG. 6. In some embodiments, a center of magnet 150 may be generally located in a corner of plate 110, spaced from edge 130 by between one inch and 0.2 inches. For example, magnet 150 may be spaced 0.625 inches from edge 130. Other spacing may also be used. A different number or placement of magnets 150 may be used. In some embodiments, magnets 150 may be secured to cover plate 110 using rivets 160. Rivets 160 provide a robust connection between magnets 150 and cover plate 110. In some embodiments, each rivet 160 may extend through a hole in magnet 150 and a hole in cover plate 110. The hole(s) in cover plate 110 may have a diameter of about 0.1 to 0.2 inches (e.g., 0.14 inches). Other diameters may be used. Rivet 160 may be located on both sides (i.e., front face 102 and back face 104) of cover plate 110, extending through the hole. Rivets 160 may be made of aluminum, stainless steel, or some other material.

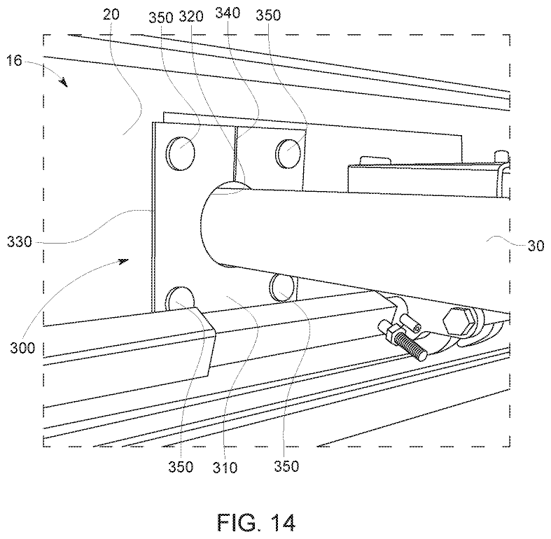

Other approaches to connect magnets 150 and cover plate 110, in addition to or instead of rivets 160, may be employed. For example, magnets 150 may be secured within trays or recesses molded into cover plate 110 (as discussed below with reference to FIGS. 14-17). As another example, magnets 150 may be connected to cover plate 110 using an adhesive or tabs or both. In some embodiments, magnets 150 may simply be secured to a flat face (front face 102 or back face 104) of cover plate 110. In some embodiments, magnets 150 may be secured to frame 20 (e.g., by adhesive, rivets, etc.) and cover plate 110 may be made of an at least partially ferrous metal. For example, one or more magnets 150 may be fixed to frame 20 around aperture 40, and a metal cover plate 110 may be attracted to magnets 150 resulting in a slidably coupled relationship between magnets 150 and cover plate 110.

In some embodiments, magnets 150 are neodymium magnets. Other types of magnets may also be used. Magnets 150 may take on a variety of shapes. For example, magnets 150 may be disc-shaped, donut-shaped, square, rectangular, etc. In some embodiments, magnets 150 may be the same shape as cover plate 110. Magnets 160 may also be a variety of different sizes (e.g., diameter, width, height, thickness, etc.). Magnets 150 may be placed on cover plate 150 to face the frame 20 (i.e., on back face 104) or magnets 150 may be on the opposite side (i.e., on front face 102), as shown in FIG. 6. Magnets 150 are strong enough and close enough to the surface of the frame member 20 to hold the cover plate 110 against the frame member 20 while also allowing a small amount of sliding on the surface of the frame member 20 while the slide rod 30 is moving in and out of the frame member 20. The strength of magnets 150 may be selected to account for the material and/or the thickness of cover plate 110. For example, a stronger magnet 150 may be used when plate 110 is made of metal. Magnet 150 may also be stronger to account for any standoff caused by rivets 160.

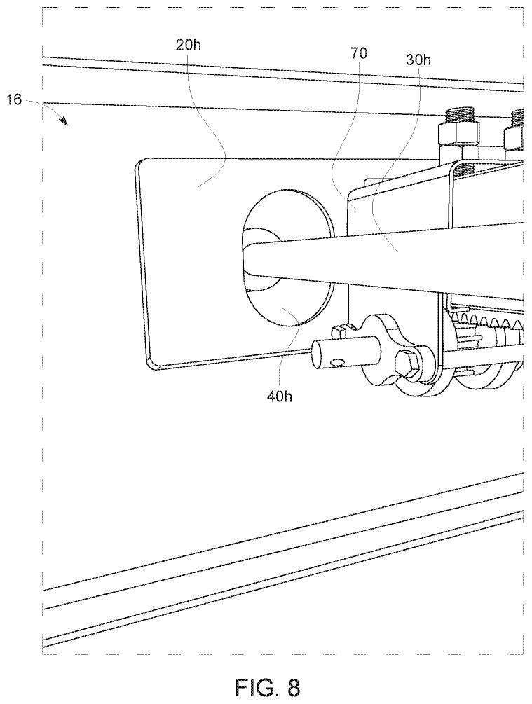

In some embodiments, features of aperture cover (e.g., material, configuration, design, etc.) may account for differences in various types of recreational vehicles. As one example, recreational vehicles that use a hydraulic slide mechanism include a hydraulic piston assembly to apply force for opening and closing the slide-out 11. As shown, for example, in FIG. 8, a hydraulic rod 30h passes through an opening 40h in the trailer frame 20h and attaches to the slide-out. The rod 30h moves in relation to the opening 40h as it actuates the slide-out in and out. As with aperture covers 100 discussed above, an aperture cover accommodates transverse movement of the rod 30h. In these instances, since the surface finish of the rod 30h is critical for hydraulic performance, the aperture cover may be specifically made of a plastic material that will not scratch the rod 30h if contact is made.

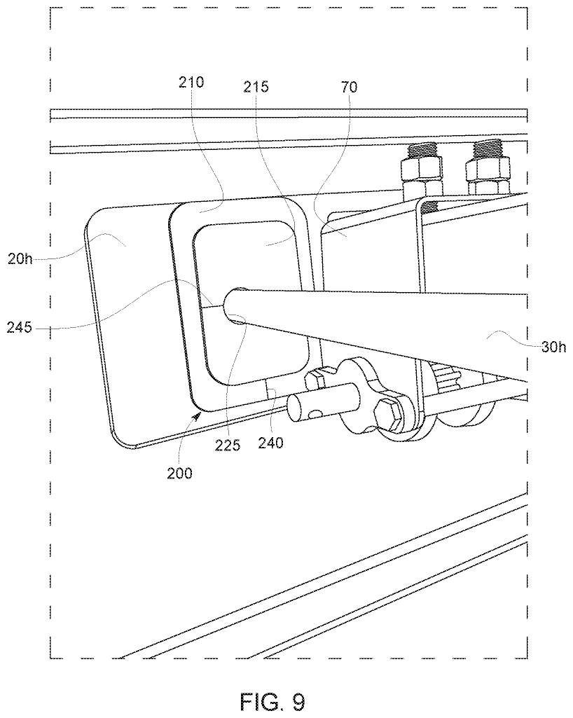

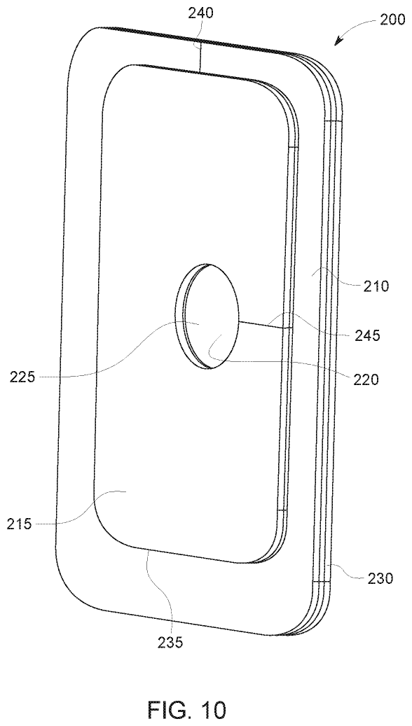

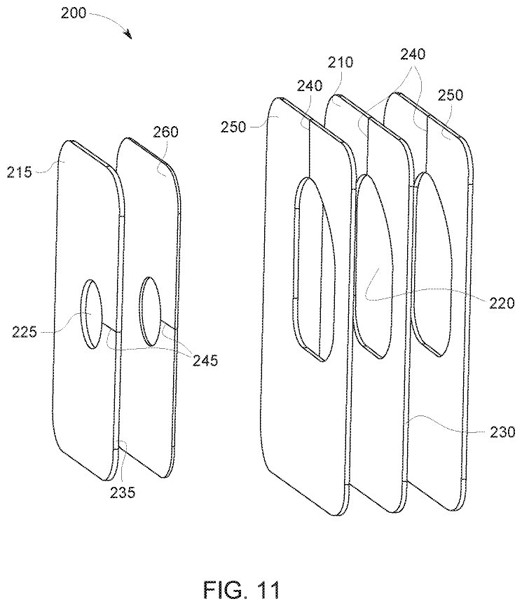

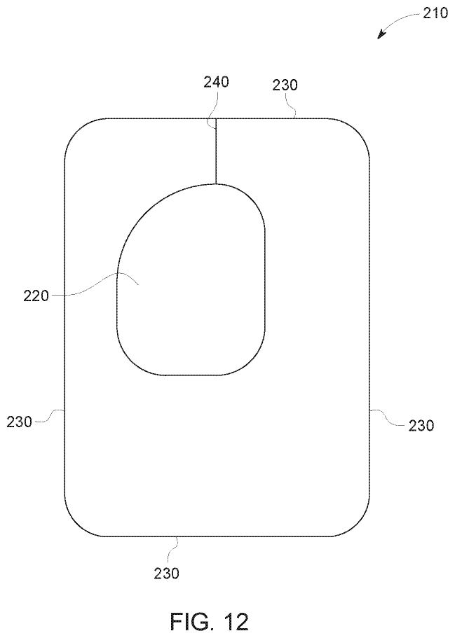

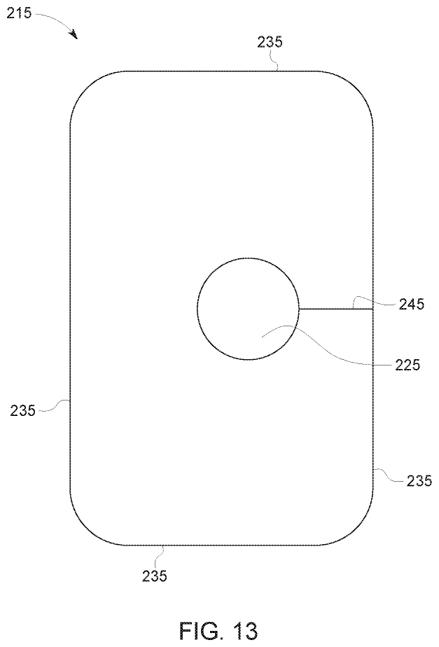

As another example, various recreational vehicles may have different constraints to placement of an aperture cover due to structure attached to the frame 20h near the opening 40h. For example, in FIG. 8, there is a structure 70 attached to frame 20h adjacent to opening 40h. Other recreational vehicles may have structure attached to frame 20h in a different location. In some embodiments, an aperture cover may accommodate these constraints for a variety of different recreational vehicle designs. An example aperture cover 200 is shown, for example, in FIGS. 9-13. Aperture cover 200 includes a base plate 210 and a top plate 215. FIG. 9 shows aperture cover 200 installed around hydraulic rod 30h. FIG. 10 shows a perspective view of aperture cover 200, while FIG. 11 shows an exploded assembly view of aperture cover 200. FIG. 12 shows a plan view of base plate 210, and FIG. 13 shows a plan view of top plate 215. The features discussed with respect to aperture cover 100 above may also be included in aperture cover 200. In addition, in some embodiments, features of aperture cover 100 and aperture cover 200 may be combined.

As noted above, aperture cover 200 includes base plate 210 and top plate 215. In some embodiments, both base plate 210 and top plate 215 are made of a plastic, which may prevent damaging the surface of hydraulic rod 30h. In some embodiments, base plate 210 includes magnets 250. For example, base plate 210 may have magnetic sheet material 250 adhered to both the front and back of base plate, as shown in the exploded view of FIG. 11. Other approaches to attaching magnetic sheet material 250 to base plate 210 may also be used. In some embodiments, base plate 210 may make contact (directly or indirectly via magnetic sheet material 250) with the frame 20 (as shown in FIG. 9) and is held to the frame 20h by the magnet sheet 250.

Similar to cover plate 110, base plate 210 comprises an opening 220, edge 230, and slot 240, as shown, for example, in FIG. 12. Base plate 210 may have other features described for cover plate 110. In some embodiments, magnet sheets 250 have the same shape as base plate 210 and may have a slot 240 and an opening 220. In some embodiments, magnet sheets 250 may be considered to be part of base plate 210. Although base plate 210 is shown as generally rectangular, other shapes may also be used. In some embodiments, base plate 210 has a height of between three inches and six inches and a width of between three inches and six inches. For example, in some embodiments, base plate 210 may have a height (or width) of 4.8 inches and a width (or height) of 3.5 inches. A variety of thicknesses may be used for base plate 210. In some embodiments, base plate 210 has a thickness of less than about 0.1 inches. For example, base plate 210 may have a thickness of about 0.06 inches. Other thicknesses may also be used. Slot 240 may provide a minor gap between two portions of base plate 210. For example, slot 240 may have a width of about 0.002 inches.

Opening 220 of base plate 210 may be smaller than aperture 40h. As such base plate 210 may at least partially cover aperture 40. In some embodiments, opening 220 is larger than a cross-section of hydraulic rod 30 so that base plate 220 does not entirely cover aperture 40h. In some embodiments, base plate 220 covers a majority of aperture 40h, and top plate 215 covers the remaining portion of aperture 40h.

Opening 220 may be asymmetrical, as shown in FIG. 12. This allows base plate 210 to be oriented differently, depending on where structure attached to frame 20h is located and where hydraulic rod 30h is located within aperture 40h. For example, if potentially interfering structure is located to the left side of aperture 40h and/or if hydraulic rod 30h is located in a left-side portion of aperture 40h, base plate 210 may be oriented as shown in FIG. 12 so that a skinniest portion of base plate 210 would be next to the potentially interfering structure, allowing opening 220 to line up with hydraulic rod 30h. If the structure was located closest to the right side of aperture 40h and/or if hydraulic rod 30h is located in a right-side portion of aperture 40h, base plate 210 may be oriented 180 degrees from what is shown in FIG. 12 so that the skinniest portion of base plate 210 would be on the right side. Base plate 210 could similarly be oriented with its skinniest portion above or below hydraulic rod 30h (oriented 90 degrees clockwise or counterclockwise, respectively, from what is shown in FIG. 12). Base plate 210 may also be oriented at some other angle. Thus, base plate 210 may be oriented in a variety of ways to accommodate the rod location within the opening 220 (no matter where it is located within aperture 40h), even with potentially interfering structure. Orienting base plate 210 may be done by rotating base plate 210 and/or by flipping base plate 210 over to a different side.

As shown in FIG. 9, base plate 210 is positioned between frame 20h and top plate 215. In some embodiments, top plate 215 has a magnetic receptive sheet material 260 adhered to the back side, as shown in the exploded view of FIG. 11. Other approaches to attaching magnetic receptive sheet material 260 to top plate 215 may also be used. In some embodiments, top plate 215 makes contact (directly or indirectly via magnetic receptive sheet material 260) with bottom plate 210 (as shown in FIGS. 9 and 10) and is held in place by the attraction of the magnetic receptive sheet 260 to the magnetic sheet material 250 on the base plate 210.

Similar to cover plate 110, top plate 215 comprises an opening 225, edge 235, and slot 245, as shown, for example, in FIG. 13. Top plate 215 may have other features described for cover plate 110. In some embodiments, magnetic receptive sheet 260 has the same shape as base plate and may have a slot 245 and an opening 225. In some embodiments, magnet receptive sheet 260 may be considered to be part of top plate 215. Although top plate 215 is shown as generally rectangular, other shapes may also be used. In some embodiments, top plate 215 has a height of between two inches and five inches and a width of between two inches and five inches. For example, in some embodiments, top plate 215 may have a height (or width) of 4 inches and a width (or height) of 2.55 inches. A variety of thicknesses may be used for top plate 215. In some embodiments, top plate 215 has a thickness of less than about 0.1 inches. For example, top plate 215 may have a thickness of about 0.06 inches. Other thicknesses may also be used. Slot 245 may provide a minor gap. For example, slot 245 may have a width of about 0.002 inches.

Opening 225 of top plate 215 may be sized to fit closely around hydraulic rod 30h, just covering whatever portion of aperture 40h that is not already covered by base plate 210 (see FIG. 9). Opening 225 may have the features discussed above for opening 120. In some embodiments, opening 225 may be sized to fit around hydraulic rod 30h with less than a 0.5 inch gap between hydraulic rod 30h and top plate 215. In some embodiments, opening 225 may be sized to fit around hydraulic rod 30h with less than a 0.1 inch gap between hydraulic rod 30h and top plate 215. In some embodiments, opening 225 may be sized to fit around hydraulic rod 30h with less than a 0.05 inch gap between hydraulic rod 30 and top plate 215. In some embodiments, opening 225 has a diameter of about 0.75 to 1.2 inches. For example, opening 225 may have a diameter of about 0.85 inches or about 1.1 inches.

The use of base plate 210 with its opening 220 as described above and top plate 215 with its opening 225 provides flexibility in covering apertures 40h of a variety of recreational vehicles 10 with different structural configurations and rod locations within aperture 40h. As hydraulic rod 30h moves in and out of aperture 40h, base plate 210 can move in relation to aperture 40h in transverse directions 34 to account for non-axial movements of hydraulic rod 30h. In addition, top plate 215 can move in relation to base plate 210 in transverse direction 34 to account for non-axial movements of hydraulic rod 30h. In some instances, non-axial movements of hydraulic rod 30h cause top plate 215 and bottom plate 210 to move together with each other (e.g., in unison). In some instances, non-axial movements of hydraulic rod 30h cause top plate 215 and bottom plate 210 to both move but separately from each other. In some instances, non-axial movements of hydraulic rod 30h cause only top plate 215 or only bottom plate 210 to move. Thus, aperture cover 200 may include top plate 215 slidingly engaged with base plate 210. In some embodiments, top plate 215 includes top plate opening 225, and base plate 210 includes opening 220 that is larger than the top plate opening 225. In some embodiments, top plate opening 225 overlaps the opening 220 in the base plate 210, thus allowing hydraulic rod 30h to extend through opening 225 and opening 220.

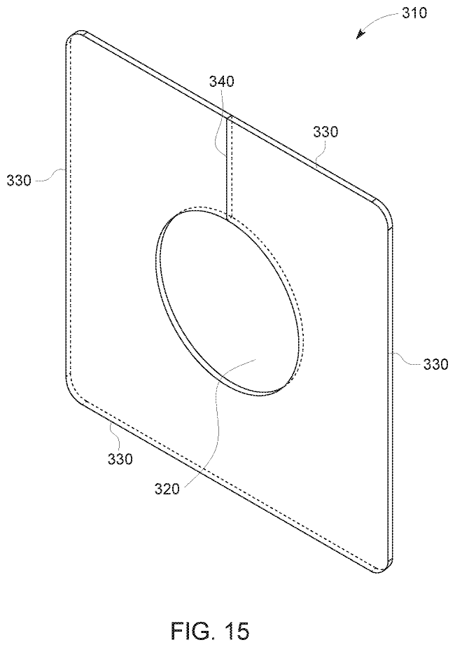

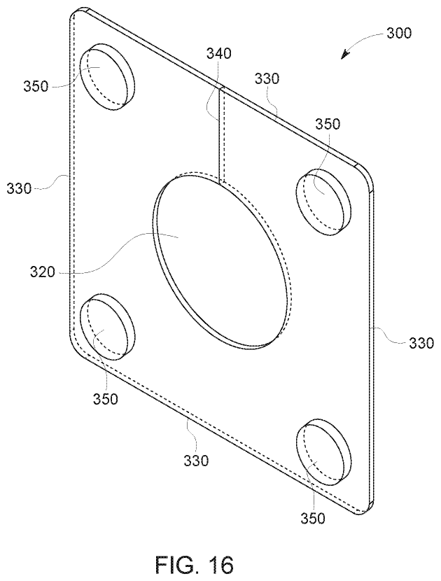

FIGS. 14-17 show another example aperture cover 300. Aperture cover 300 may have the features discussed above with respect to aperture cover 100. For example, aperture cover 300 may include a cover plate 310 and magnets 350. In some embodiments, cover plate 310 defines an opening 320 and has an edge 330 and a slit 340. These features of aperture cover 300 may have any of the features described above for aperture cover 100. FIG. 14 shows aperture cover 300 installed in lower frame area 16 of a recreational vehicle around shaft 30. FIG. 15 shows a perspective view of a cover plate 310 of aperture cover 300, and FIG. 16 shows a perspective view of aperture cover 300, including both cover plate 310 and magnets 350 connected to cover plate.

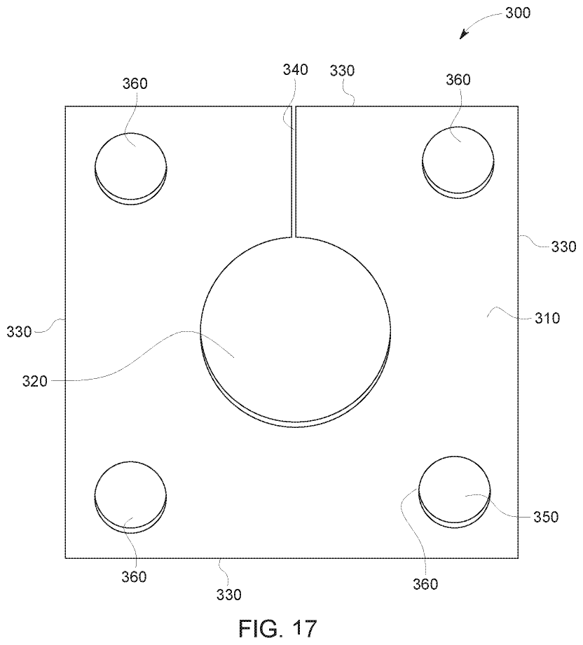

In some embodiments, as shown, for example, in FIG. 17, aperture cover 300 includes magnet receiving areas 360. Magnet receiving areas 360 may be recesses 360 within cover plate 310. Magnets 350 may be secured within recesses 360 with an adhesive, a tab, or both. In some embodiments, magnet receiving areas 360 may be holes that extend through an entire thickness of cover plate 310, with magnets 350 adhered within the holes. In some embodiments, magnet receiving areas may be some other structure, such as a protruding receptacle configured to hold magnets 350 therein.

While various embodiments have been described herein, these embodiments are provided for illustration. Thus, other embodiments may be envisioned within the basic concepts and executions disclosed herein to achieve the favorable results of better sealing (more closely closing off) of an opening whether for trailers and other recreational vehicles or for other openings. This may be employed wherever an opening is used with a shaft that moves in and out of the opening while not moving in and out in a perfectly straight line. Thus, various embodiments allow side-to-side movement of the cover plate to maintain a closer fit to the shaft it is following and sealing around.

1. An aperture cover to at least partially obstruct the space between a slide member and a wall opening through which the slide member extends for in-and-out movement relative to the wall opening, the cover comprising:
a plate having a width and a height larger than a width and height of the wall opening, wherein the plate includes an opening sized to closely fit transversely on the slide member; and
at least one magnet secured to the plate between an edge of the plate and the plate opening.

2. The aperture cover of claim 1, wherein the plate includes a slot extending from the plate opening to the edge.

3. The aperture cover of claim 2, wherein the plate is flexible such that the plate can be separated at the slot for insertion onto the slide member.

4. The aperture cover of claim 1, wherein the at least one magnet includes magnets secured to the plate on opposite sides of the plate opening.

5. The aperture cover of claim 1, wherein the at least one magnet is riveted onto the plate.

6. The aperture cover of claim 1, wherein the at least one magnet is adhesively applied to a front face or a back face of the plate.

7. The aperture cover of claim 1, wherein the plate includes a recess, the at least one magnet being held in the recess.

8. The aperture cover of claim 1, wherein the plate comprises a base plate and a top plate slidingly engaged with the base plate and having a top plate opening, the base plate having a larger opening than the top plate opening, the top plate opening overlapping the opening in the base plate.

9. The aperture cover of claim 8, wherein the base plate includes a base magnet sheet on a backside thereof for engagement with the wall.

10. The aperture cover of claim 9, wherein the top plate includes a magnet receptor to slidingly engage with the base plate.

11. The aperture cover of claim 9, wherein the top plate includes a slot extending from the top plate opening to an edge of the top plate.

12. The aperture cover of claim 1, wherein the plate is formed of steel, plastic, or composite.

13. A method of covering a gap between the sides of a shaft and the edges of a metal wall opening with a plate as in claim 1, the method comprising:
securing the plate on the shaft with the shaft extending through the opening in the plate; and
engaging the at least one magnet with the metal wall.

14. The method of claim 13, wherein the plate includes a slot extending from the opening in the plate to an edge of the plate, and wherein the plate is secured onto the shaft by separating the plate at the slot to slide over the shaft

15. The method of claim 13, wherein the cover includes a plurality of magnets secured to a face of the plate, at least two of the magnets being on opposite sides of the opening in the plate.

16. The method of claim 13, wherein the plate comprises a base plate and a top plate slidingly coupled to the base plate and having a top plate opening that overlaps with an opening in the base plate.

17. The method of claim 16, wherein the top plate moves relative to the base plate when the shaft moves transverse to its longitudinal axis.

18. An aperture cover to at least partially obstruct the space between a slide member and a metal frame wall opening through which the slide member extends for in-and-out movement relative to the metal frame wall opening on a recreational vehicle, the cover comprising:
a flexible plate having a width and a height larger than a width and height of the wall opening, wherein the plate includes an opening sized to closely fit transversely on the slide member, the plate having a slot from the plate opening to an edge of the plate; and
at least two magnets secured to the plate between an edge of the plate and the plate opening, the magnets being secured on opposite sides of the plate opening.

19. The aperture cover of claim 18, wherein the plate is formed of spring steel.

20. The aperture cover of claim 18, wherein the plate comprises a base plate and a top plate slidably coupled to a face of the base plate, the top plate having a top plate opening smaller than a base plate opening and overlapping with the base plate opening.

21. A system for at least partially obstructing the space between a slide member and an opening in a surface through which the slide member extends for in-and-out movement relative to the opening, the system comprising:
a metal plate having a width and a height larger than a width and height of the opening in the surface, wherein the metal plate includes an opening sized to closely fit transversely on the slide member; and
at least one magnet secured to the surface,
wherein the metal plate is magnetically attracted to the at least one magnet such that the metal plate and the at least one magnet are slidably coupled.

22. The system of claim 21, wherein the metal plate has a slot from the metal plate opening to an edge of the metal plate.

23. The system of claim 21, wherein the at least one magnet is riveted onto the surface.

24. The system of claim 1, wherein the at least one magnet is adhesively applied to the surface.

25. The aperture cover of claim 1, wherein the plate is formed from a single piece of material.
